(19) United States
(12) Patent Application Publication
(10) Pub. No.: US 2012/0263947 A1
(43) Pub. Date: Oct. 18, 2012

(54) PRESSURE-SENSITIVE ADHESIVE LAYER-ATTACHED TRANSPARENT RESIN FILM, LAMINATED FILM, AND TOUCH PANEL

(75) Inventors: Hiroki Ozawa, Ibaraki-shi (JP); Hiroyuki Takao, Ibaraki-shi (JP); Hideo Sugawara, Ibaraki-shi (JP)

(73) Assignee: NITTO DENKO CORPORATION, Osaka (JP)

(21) Appl. No.: 13/441,113

(22) Filed: Apr. 6, 2012

(30) Foreign Application Priority Data
Apr. 15, 2011 (JP) 2011-090873

(51) Int. Cl. B32B 7/12; B32B 27/08

(52) U.S. Cl. 428/354; 428/447

(57) ABSTRACT

A pressure-sensitive adhesive layer-attached transparent resin film of the invention includes a first transparent resin film, an oligomer blocking layer, and a pressure-sensitive adhesive layer, which are laminated in this order, wherein the oligomer blocking layer is made of a curing product of alkoxysilane and/or a partial condensate thereof, and the oligomer blocking layer has a thickness of 5 nm to 35 nm. The pressure-sensitive adhesive layer-attached transparent resin film can has satisfactory oligomer-blocking properties as desired, and provides good adhesion of the oligomer blocking layer.

### BACKGROUND OF THE INVENTION

1. Field of the Invention

The invention relates to a pressure-sensitive adhesive layer-attached transparent resin film including a first transparent resin film, an oligomer blocking layer, and a pressure-sensitive adhesive layer, which are laminated in this order. For example, the pressure-sensitive adhesive layer-attached transparent resin film is used to form a laminated film, which includes the pressure-sensitive adhesive layer-attached transparent resin film and a second transparent resin film placed thereon with the pressure-sensitive adhesive layer interposed therebetween. The laminated film can be used in various applications such as optical applications.

For example, when the second transparent resin film has a transparent conductive thin layer, the laminated film can be used to form a laminate of transparent conductive film. The transparent conductive film can be used to form a transparent electrode for a display such as a liquid crystal display or an electroluminescence display or a touch panel such as an optical, ultrasonic, capacitance, or resistive touch panel. In addition, the transparent conductive film can be used for electromagnetic wave shielding or prevention of static buildup on transparent products and to form liquid crystal dimming glass products, transparent heaters, etc.

2. Description of the Related Art

Touch panels produced using a transparent conductive film as an electrode can be classified according to the position sensing method into an optical type, a capacitance type, a resistive type, and others. Resistive touch panels are configured to include a transparent conductive film and a transparent conductor-attached glass plate, which are arranged opposite to each other with spacers interposed therebetween, in which an electric current is allowed to flow through the transparent conductive film, while the voltage at the transparent conductor-attached glass plate is measured.

Concerning the transparent conductive film, there has been proposed a transparent conductive laminated film including: a conductive film having a transparent film substrate and a transparent conductive thin layer provided on one surface of the substrate; and another transparent substrate having a hard coat layer as an outer surface layer provided on the other surface of the transparent film substrate with a pressure-sensitive adhesive layer interposed therebetween so that the laminated film can withstand scratching or taps during pressing operation.

When the transparent conductive laminated film is incorporated into an electronic device such as a touch panel, a lead is provided at an edge of the transparent conductive layer using a silver paste. For example, such a lead is formed by a method including heating a conductive paste at about 100 to 150° C. for about 1 to 2 hours to cure the paste.

Unfortunately, there is a problem in which when a transparent resin film such as a polyethylene terephthalate film is used as a transparent film substrate to form a transparent conductive laminated film, low-molecular-weight components (oligomers) in the transparent film substrate can be precipitated by heating to whiten the transparent conductive laminated film. Thus, the transparent conductive laminate has the problem of degradation of the visibility of a screen. Against these problems, it has been proposed that an oligomer blocking layer should be provided on the transparent film substrate (see below Patent Documents 1 to 3).

1: JP-A No. 2002-013504

2: JP-A No. 07-013695

3: JP-A No. 2003-24697

### SUMMARY OF THE INVENTION

Various materials have been proposed as materials for forming the oligomer blocking layer. Unfortunately, when an oligomer blocking layer is formed on a transparent film substrate, the adhesion between the transparent film substrate and the oligomer blocking layer or the interlayer adhesion between the transparent film substrate and another transparent substrate in the transparent conductive laminate is insufficient in some cases, depending on the material used to form the oligomer blocking layer. On the other hand, electronic devices such as touch panels have been reduced in thickness, and therefore, transparent conductive laminates have been required to be thinner.

An object of the invention is to provide a pressure-sensitive adhesive layer-attached transparent resin film, which includes a first transparent resin film, an oligomer blocking layer, and a pressure-sensitive adhesive layer laminated in this order, that has satisfactory oligomer-blocking properties as desired, and provides good adhesion of the oligomer blocking layer.

Another object of the invention is to provide a laminated film produced using such the pressure-sensitive adhesive layer-attached transparent resin film and to provide a touch panel produced using such the laminated film as a transparent conductive film.

As a result of earnest studies to solve the above problems, the inventors have accomplished the invention based on the finding that the objects can be achieved using the features described below.

The invention relates to a pressure-sensitive adhesive layer-attached transparent resin film, including a first transparent resin film, an oligomer blocking layer, and a pressure-sensitive adhesive layer, which are laminated in this order,

wherein the oligomer blocking layer is made of a curing product of alkoxysilane and/or a partial condensate thereof, and

the oligomer blocking layer has a thickness of 5 nm to 35 nm.

In the pressure-sensitive adhesive layer-attached transparent resin film, a polyester resin film is used as the first transparent resin film.

In the pressure-sensitive adhesive layer-attached transparent resin film, the pressure-sensitive adhesive layer is preferably an acrylic pressure-sensitive adhesive layer.

The invention also relates to a laminated film, including the above pressure-sensitive adhesive layer-attached transparent resin film and a second transparent resin film bonded thereto with the pressure-sensitive adhesive layer of the pressure-sensitive adhesive layer-attached transparent resin film interposed therebetween.

In the laminated film, a transparent conductive film having a transparent conductive layer is used as the second transparent resin film, placed directly on one side where the pressure-sensitive adhesive layer is not bonded, or placed on the one side with an undercoat layer interposed therebetween.

The invention also relates to a touch panel including the above laminated film having the transparent conductive film.

In the pressure-sensitive adhesive layer-attached transparent resin film of the invention, the oligomer blocking layer made of a curing product of alkoxysilane and/or a partial condensate thereof can satisfy the desired oligomer blocking properties. Therefore, even when the pressure-sensitive adhesive layer-attached transparent resin film is heat-treated, oligomers can be prevented from precipitating from the first transparent resin film to the pressure-sensitive adhesive layer side, which suppresses the whitening of the pressure-sensitive adhesive layer-attached transparent resin film to maintain its good appearance, and also suppresses the whitening of the laminated film produced with the pressure-sensitive adhesive layer-attached transparent resin film to maintain its good appearance.

The oligomer blocking layer, which is made of a curing product of alkoxysilane and/or a partial condensate thereof, has a controlled thickness in the range of 5 to 35 nm, and therefore provides a high anchoring force between the first transparent resin film and the pressure-sensitive adhesive layer. Thus, the laminated film formed using the pressure-sensitive adhesive layer-attached transparent resin film also has good interlayer adhesion between the first transparent resin film and the second transparent resin film and shows good adhesion against moisture.

### BRIEF DESCRIPTION OF THE DRAWINGS

FIG. 1A is a cross-sectional view showing an exemplary embodiment of the pressure-sensitive adhesive layer-attached transparent resin film of the invention;

FIG. 1B is a cross-sectional view showing an exemplary embodiment of the pressure-sensitive adhesive layer-attached transparent resin film of the invention;

FIG. 2A is a cross-sectional view showing an exemplary embodiment of the laminated film of the invention;

FIG. 2B is a cross-sectional view showing an exemplary embodiment of the laminated film of the invention.

### DETAILED DESCRIPTION OF THE PREFERRED EMBODIMENTS

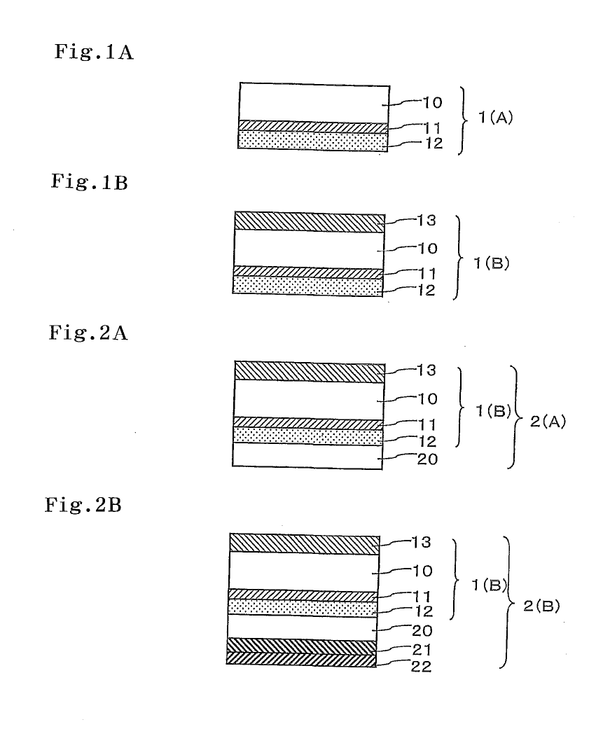

The embodiment of the pressure-sensitive adhesive layer-attached transparent resin film and the laminated film of the invention are described below with reference to the drawings. FIGS. 1(A) and 1(B) are cross-sectional views each showing an example of the pressure-sensitive adhesive layer-attached transparent resin film 1 of the invention. As shown in FIG. 1A, the pressure-sensitive adhesive layer-attached transparent resin film 1(A) includes a first transparent resin film 10, an oligomer blocking layer 11, and a pressure-sensitive adhesive layer 12 laminated in this order. The pressure-sensitive adhesive layer-attached transparent resin film 1(B) shown in FIG. 1(B) is a modification of the pressure-sensitive adhesive layer-attached transparent resin film 1(A), in which the first transparent resin film 10 is provided with a functional layer (such as a hard coating layer) 13 placed on the opposite side from the pressure-sensitive adhesive layer 12. Alternatively, the functional layer 13 may be placed between the oligomer blocking layer 11 and the pressure-sensitive adhesive layer 12.

FIGS. 2A and 2B are cross-sectional views each showing an example of the laminated film 2 of the invention. The laminated film 2(A) of FIG. 2A includes the pressure-sensitive adhesive layer-attached transparent resin film 1(B), which is shown in FIG. 1B, and a second transparent resin film 20 placed on the pressure-sensitive adhesive layer 12 of the film 1(B). The laminated film 2(B) of FIG. 2B is a modification of the film of FIG. 2A, in which a transparent conductive layer 22 is provided on the other side of the second transparent resin film 20, which is not bonded to the pressure-sensitive adhesive layer 12, with an undercoat layer 21 interposed therebetween. The laminated film 2(B) of FIG. 2B can be used as a transparent conductive film. While FIG. 2B shows that the transparent conductive layer 22 is provided through the undercoat layer 21, alternatively, the transparent conductive layer 22 may be provided directly on the second transparent resin film 20 without the undercoat layer 21. The pressure-sensitive adhesive layer-attached transparent resin film 1(A) shown in FIG. 1A is also applicable to the mode of FIG. 2A or 2B.

First, a description is given of the pressure-sensitive adhesive layer-attached transparent resin film 1 of the invention. The pressure-sensitive adhesive layer-attached transparent resin film 1 has the oligomer blocking layer 11 and the pressure-sensitive adhesive layer 12, which are provided in this order on one side of the first transparent resin film 10.

The material for the first transparent resin film 10 is not restricted, and it may be made of any of a variety of plastic materials having transparency. Examples of such materials include polyester resins such as polyethylene terephthalate and polyethylene naphthalate, acetate resins, polyether sulfone resins, polycarbonate resins, polyamide resins, polyimide resins, polyolefin resins, (meth)acrylic resins, polyvinyl chloride resins, polyvinylidene chloride resins, polystyrene resins, polyvinyl alcohol resins, polyarylate resins, and polyphenylene sulfide resins. In particular, polyester resins, polyimide resins, and polyether sulfone resins are preferred.

The resin composition disclosed in JP-A No. 2001-343529 (WO10/37007) may also be used, which contains a thermoplastic resin having a substituted and/or unsubstituted imide group in the side chain and another thermoplastic resin having substituted and/or unsubstituted phenyl and nitrile groups in the side chain. More specifically, a resin composition containing an isobuthylene and N-methylmaleimide alternating copolymer and an acrylonitrile-styrene copolymer may be used as a material for the resin film.

The first transparent resin film 10 used may be a film stretched in at least one direction. The stretching process may be any of various stretching processes such as uniaxial stretching, simultaneous biaxial stretching, and sequential biaxial stretching. In view of mechanical strength, the first transparent resin film 10 is preferably a biaxially stretched resin film.

The first transparent resin film 10 is generally formed of a monolayer film. In general, the first transparent resin film 10 preferably has a thickness of 90 to 300 μm, more preferably 100 to 250 μm.

The oligomer blocking layer 11 is made of a curing product of alkoxysilane and/or a partial condensate thereof. The oligomer blocking layer 11 has functions such as preventing migration of migrant components in the first transparent resin film 10, typically, migration of low-molecular-weight polyester oligomer components, which are migrant components in a polyester resin film.

The oligomer blocking layer 11 has a thickness of 5 to 35 nm, because sufficient interlayer adhesion and oligomer holding function should be imparted to the oligomer blocking layer 11. When the thickness of the oligomer blocking layer 11 is 5 nm or more, an oligomer holding function is provided. On the other hand, if the oligomer blocking layer 11 is too thick, adhesion between the oligomer blocking layer 11 and the first transparent resin film 10 or the pressure-sensitive adhesive layer 12 may be insufficient, and therefore, the thickness of the oligomer blocking layer 11 is controlled to 35 nm or less. The thickness of the oligomer blocking layer 11 is preferably from 5 to 25 nm, more preferably from 10 to 25 nm.

The alkoxysilane may be a material commonly used in sol-gel methods. Examples of the alkoxysilane include compounds represented by formula (1): R¹ₓSi(OR²)₄₋ₙ, wherein x represents an integer of 0 to 2, R¹ represents a lower alkyl, allyl, or aryl group optionally having a functional group such as an epoxy, amino, (meth)acryloyl, isocyanate, or mercapto group, R¹ moieties may be the same or different, and R² represents a hydrogen atom or a lower alkyl group. The lower alkyl group refers to a straight or branched chain alkyl group of 6 or less carbon atoms.

Examples of the alkoxysilanes represented by formula (1) above include tetraalkoxysilanes for x=0, such as tetramethoxysilane, tetraethoxysilane, tetrapropoxysilane, tetraisopropoxysilane, and tetrabutoxysilane; trialkoxysilanes for x=1, such as methyltrimethoxysilane, methyltriethoxysilane, methyltripropoxysilane, methyltributoxysilane, ethyltrimethoxysilane, ethyltriethoxysilane, n-propyltrimethoxysilane, n-propyltriethoxysilane, isopropyltrimethoxysilane, isopropyltriethoxysilane, vinyltrimethoxysilane, vinyltriethoxysilane, 3-glycidoxypropyltrimethoxysilane, 3-glycidoxypropyltriethoxysilane, 3-mercaptopropyltrimethoxysilane, 3-mercaptopropyltriethoxysilane, phenyltrimethoxysilane, phenyltriethoxysilane, 3,4-epoxycyclohexylethyltrimethoxysilane, and 3,4-epoxycyclohexylethyltrimethoxysilane; and dialkoxysilanes for x=2, such as dimethyldimethoxysilane, dimethyldiethoxysilane, diethyldimethoxysilane, diethyldiethoxysilane, γ-glycidoxypropylmethyldimethoxysilane, and γ-mercaptopropylmethyldimethoxysilane. The alkoxysilanes are preferably tetraalkoxysilanes and/or trialkoxysilanes. These alkoxysilanes may be used singly or in combination of two or more.

A partial condensate of alkoxysilane is a hydrolysis-partial condensation product of two or more molecules of one or more alkoxysilanes. While the degree of condensation of alkoxysilane is not restricted, an alkoxysilane condensate having 2 to 8 Si atoms on average per molecule is preferred because of its good handleability. The structure of the condensate is not restricted, and it may have any of a straight chain structure and a branched structure, in which a bond via an oxygen atom may be present between branched chains or between a branched chain and a main chain.

The oligomer blocking layer 11 is made of a cured product derived from alkoxysilane and/or a partial condensate thereof. Alkoxysilane and/or a partial condensate thereof can be cured by hydrolysis-condensation reaction. Therefore, an appropriate catalyst may be added to alkoxysilane and/or a partial condensate thereof to accelerate the curing. The curing can also be carried out at room temperature or under heating. A photo-acid generator or a photo-base generator may also be added to alkoxysilane and/or a partial condensate thereof to accelerate the curing under light irradiation.

Examples of the catalyst include inorganic acids such as hydrochloric acid, sulfuric acid, and nitric acid; organic acids such as oxalic acid, acetic acid, formic acid, and methanesulfonic acid; inorganic bases such as sodium hydroxide, potassium hydroxide, and ammonia; organic bases such as triethylamine and pyridine; and metal alkoxides such as triisopropoxy aluminum and tetrabutoxy zirconium, and metal chelate compounds of the metal alkoxides.

Examples of the photo-acid generator include benzoin tosylate, tri(nitrobenzene) phosphate, diaryliodonium salts, and triarylsulfonium salts. Examples of the photo-base generator include nitrobenzyl cyclohexylcarbamate and di(methoxybenzyl) hexamethylene carbamate.

Alkoxysilane and/or a partial condensate thereof may be subjected to hydrolysis-condensation reaction under solvent-free conditions or in a solvent solution. Examples of the solvent include ketones such as acetone, methyl ethyl ketone, methyl isobutyl ketone, diethyl ketone, dipropyl ketone, diisobutyl ketone, cyclopentanone, cyclohexanone, methyl cyclohexanone, 2-octanone, 2-pentanone, 2-hexanone, 2-heptanone, and 3-heptanone; esters such as ethyl formate, propyl formate, n-pentyl formate, methyl acetate, ethyl acetate, butyl acetate, n-pentyl acetate, methyl propionate, and ethyl propionate; monovalent alcohols such as methanol, ethanol, 1-propanol, 2-propanol, 1-butanol, 2-butanol, 1-pentanol, 2-methyl-2-butanol, and cyclohexanol; aromatics such as benzene, toluene, and xylene; ethers such as dibutyl ether, dimethoxymethane, dimethoxyethane, diethoxyethane, propylene oxide, 1,4-dioxane, 1,3-dioxolane, 1,3,5-trioxane, and tetrahydrofuran; acetylacetones such as acetylacetone, diacetone alcohol, methyl acetoacetate, and ethyl acetoacetate; glycol ethers such as ethylene glycol monoethyl ether acetate, ethylene glycol monoethyl ether, ethylene glycol monobutyl ether, ethylene glycol monomethyl ether, propylene glycol monomethyl ether acetate, and propylene glycol monomethyl ether. These solvents may be used singly or in combination of two or more.

The oligomer blocking layer 11 is made of a curing product of the alkoxysilane and/or a partial condensate thereof. For example, a method of forming the oligomer blocking layer 11 includes: applying a silica sol to the first transparent resin film 10, wherein the silica sol is obtained by hydrolysis-condensation including mixing a composition containing alkoxysilane and/or a partial condensate thereof and the catalyst and other additives or mixing a solution of the composition; and drying the coating. The silica sol may be a commercially available product such as COLCOAT series (manufactured by COLCOAT CO., Ltd.). The silica sol may be applied by any of various methods including known methods such as spray coating, gravure coating, roll coating, bar coating, and die coating. The application is performed so that the finally resulting oligomer blocking layer 11 can have a thickness of 5 to 35 nm.

Alternatively, the oligomer blocking layer 11 may be formed by a method including: applying, directly to the first transparent resin film 10, a composition containing alkoxysilane and/or a partial condensate thereof and the catalyst and other additives, or a solution of the composition; and curing and drying the coating.

The composition may be appropriately diluted with a solvent to form a composition solution before use. Such a composition solution containing the composition and the solvent may be subjected to a process including applying the composition solution containing the solvent to the first transparent resin film 10 to form a coating layer, then removing the solvent by drying, and curing the coating layer. When the composition contains a photo-acid generator or a photo-base generator, light irradiation is carried out as appropriate.

The pressure-sensitive adhesive layer-attached transparent resin film 1 may also have a functional layer (hard coating layer) 13, which is provided on the other side of the first transparent resin film 10 where the oligomer blocking layer 11 is not provided.

For example, a hard coating layer may be provided as the functional layer 13 to protect the outer surface. A cured film derived from curable resin such as melamine resin, urethane resin, alkyd resin, acrylic resin, or silicone resin may be used as a material to form the hard coating layer. The hard coating layer preferably has a thickness of 0.1 to 30 μm. Setting the thickness at 0.1 μm or more is preferred to provide hardness. If the thickness is more than 30 μm, the hard coating layer may be cracked, or curling may occur across the pressure-sensitive adhesive layer-attached transparent resin film 1.

An anti-glare layer or an anti-reflection layer may also be provided as the functional layer 13 to improve visibility. The anti-glare layer or the anti-reflection layer may be provided on the hard coating layer. The material used to form the anti-glare layer is typically, but not limited to, ionizing radiation-curable resin, thermosetting resin, thermoplastic resin, or others. The anti-glare layer preferably has a thickness of 0.1 to 30 μm. The anti-reflection layer may be formed using titanium oxide, zirconium oxide, silicon oxide, magnesium fluoride, or others. A plurality of anti-reflection layers may be provided.

The pressure-sensitive adhesive layer 12 used may be of any type, as long as it has transparency. For example, a material including, as a base polymer, an acryl-based polymer, a silicone-based polymer, polyester, polyurethane, polyamide, polyvinyl ether, a vinyl acetate-vinyl chloride copolymer, modified polyolefin, or a rubber-based polymer such as an epoxy, fluoride, natural rubber, or synthetic rubber may be appropriately selected and used. In particular, an acrylic pressure-sensitive adhesive is preferably used because it has a high level of optical transparency, and exhibits appropriate adhesive properties such as appropriate wettability, cohesiveness, and tackiness and so on weather resistance, heat resistance.

The pressure-sensitive adhesive layer 12 may also contain a crosslinking agent, depending on the base polymer. If necessary, the pressure-sensitive adhesive layer 12 may also contain appropriate additives such as natural or synthetic resins, glass fibers or glass beads, fillers of metal powder or any other inorganic powder, pigments, colorants, and antioxidants. Transparent fine particles may also be added to impart light diffusion properties to the pressure-sensitive adhesive layer 12.

For example, the transparent fine particles may be fine particles with an average particle size of 0.5 to 20 μm made of one or more of conductive inorganic materials such as silica, calcium oxide, alumina, titania, zirconia, tin oxide, indium oxide, cadmium oxide, and antimony oxide, and crosslinked or uncrosslinked organic materials of appropriate polymers such as poly(methyl methacrylate) and polyurethane.

The pressure-sensitive adhesive layer 12 is generally made from a pressure-sensitive adhesive solution (with a solids concentration of about 10 to 50% by weight) in which a base polymer or a composition thereof is dissolved or dispersed in a solvent. An organic solvent such as toluene or ethyl acetate, water, or other solvents may be appropriately selected and used as the solvent, depending on the type of the pressure-sensitive adhesive.

The pressure-sensitive adhesive layer 12 may be formed on the oligomer blocking layer 11. Examples of the method of forming it include, but are not limited to, a method including applying a pressure-sensitive adhesive (solution) to the oligomer blocking layer 11 and drying it, and a method including providing a pressure-sensitive adhesive layer on a release film and transferring it from the release film to the oligomer blocking layer 11. The method of application may be roll coating such as reverse coating or gravure coating, spin coating, screen coating, fountain coating, dipping, or spraying.

A laminated film 2 is obtained after the pressure-sensitive adhesive layer-attached transparent resin film 1 is bonded to the second transparent resin film 20 (including the case of a transparent conductive film) described below. In the laminated film 2, the pressure-sensitive adhesive layer 12 has a cushion effect and thus can function to improve the scratch resistance of a transparent conductive layer 22 formed on one side of the second transparent resin film 20 and to improve tap properties, so-called pen input durability and contact pressure durability, as a touch panel-forming transparent conductive film. In order to perform this function better, it is preferred that the elastic modulus of the pressure-sensitive adhesive layer 12 should be set in the range of 1 to 100 N/cm² and that its thickness should be set to 1 μm or more, generally in the range of 5 to 100 μm. With such a thickness, the effect is sufficiently produced, and a satisfactory adhesive strength is provided between the second transparent resin film 20 and the pressure-sensitive adhesive layer 12 of the pressure-sensitive adhesive layer-attached transparent resin film 1. If the thickness is less than the above range, the durability or adhesion cannot be ensured sufficiently, and if the thickness is more than the above range, the appearance such as the transparency may be degraded.

If the elastic modulus is less than 1 N/cm², the pressure-sensitive adhesive layer 12 may be inelastic so that it can be easily deformed by pressing, so that irregularities may be formed on the second transparent resin film 20 and further on the transparent conductive layer 22, which is provided on the second transparent resin film 20. In addition, the pressure-sensitive adhesive can also be easily squeezed out of the cut section, and the effect of improving the scratch resistance of the transparent conductive layer 22 or improving the tap properties of the film as a touch panel-forming transparent conductive film can be reduced. If the elastic modulus is more than 100 N/cm², the pressure-sensitive adhesive layer 12 can be hard, and the cushion effect cannot be expected, so that the scratch resistance of the transparent conductive layer 22 or the pen input durability and contact pressure durability of the touch panel-forming transparent conductive film may tend to be difficult to improve.

If the thickness of the pressure-sensitive adhesive layer 12 is less than 1 μm, the cushion effect also cannot be expected, so that the scratch resistance of the transparent conductive layer 22 or the pen input durability and contact pressure durability of the touch panel-forming transparent conductive film may tend to be difficult to improve. If the pressure-sensitive adhesive layer is too thick, it may reduce the transparency, or good results may be difficult to obtain with respect to the formation of the pressure-sensitive adhesive layer 12, the workability of the lamination of the pressure-sensitive adhesive layer 12 of the pressure-sensitive adhesive layer-attached transparent resin film 1 and the second transparent resin film 20, and cost.

The laminated film 2(B) produced by the lamination of the films with such a pressure-sensitive adhesive layer 12 interposed therebetween provides good mechanical strength, pen input durability, and contact pressure durability, and in addition, particularly contributes to the prevention of curling and the like.

The adhesive strength between the oligomer blocking layer 11 and the pressure-sensitive adhesive layer 12 is preferably 1.5 N/25 mm or more, more preferably 2 N/25 mm or more, even more preferably 3 N/25 mm or more, still more preferably 4 N/25 mm or more. Setting the adhesive strength at 4 N/25 mm or more makes it possible to suppress the deformation of the pressure-sensitive adhesive layer under pen input pressure, for example, when the resulting transparent conductive laminate is used in a touch panel.

The pressure-sensitive adhesive layer 12 may be protected by a release film until it is subjected to the lamination. The release film that may be used is preferably a polyester film having a migration-preventing layer and/or a release layer formed on the surface to be bonded to the pressure-sensitive adhesive layer 12.

The entire thickness of the release film is preferably 30 μm or more, more preferably in the range of 60 to 100 μm. This is to prevent the deformation (dents) of the pressure-sensitive adhesive layer 12 in a case where the pressure-sensitive adhesive layer 12 is formed and then stored in the form of a roll, in which the deformation (dents) would be assumed to occur due to foreign particles or the like intruding between portions of the rolled layer.

The migration-preventing layer may be made of an appropriate material for preventing migration of migrant components in a polyester film, particularly for preventing migration of low-molecular-weight oligomer components in a polyester film. An inorganic or organic material or a composite of inorganic and organic materials may be used to form the migration-preventing layer. The thickness of the migration-preventing layer may be appropriately set in the range of 0.01 to 20 μm. The migration-preventing layer may be formed, but not limited to, using any method such as coating, spraying, spin coating, or in-line coating. Vacuum deposition, sputtering, ion plating, spray thermal decomposition, chemical plating, electroplating, or the like may also be used.

The release layer may be made of an appropriate release agent such as a silicone release agent, a long-chain alkyl release agent, a fluoride release agent, or molybdenum sulfide. The thickness of the release layer may be set as appropriate in view of the release effect. In general, the thickness is preferably 20 μm or less, more preferably in the range of 0.01 to 10 μm, in particular preferably in the range of 0.1 to 5 μm, in view of handleability such as flexibility. The method of forming the release layer is not restricted, and it may be formed using the same method as that of forming the migration-preventing layer.

An ionizing radiation-curable resin such as an acrylic resin, a urethane resin, a melamine resin, or an epoxy resin or a mixture of any of the above resins and aluminum oxide, silicon dioxide, mica, or the like may be used in the coating, spraying, spin coating, or in-line coating method. When a vacuum deposition, sputtering, ion plating, spray thermal decomposition, chemical plating, or electroplating method is used, an a metal such as gold, silver, platinum, palladium, copper, aluminum, nickel, chromium, titanium, iron, cobalt, or tin, an oxide of an alloy thereof, or any other metal compounds such as metal iodides may be used.

The laminated film 2 of the invention can be formed by placing the second transparent resin film 20 on the pressure-sensitive adhesive layer 12 of the pressure-sensitive adhesive layer-attached transparent resin film 1.

A transparent conductive layer 22 may be provided directly on the other side of the second transparent resin film 20, where the pressure-sensitive adhesive layer 12 is not bonded, or provided on the other side of the second transparent resin film 20 with an undercoat layer interposed therebetween.

The anchoring force can be improved using an appropriate pressure-sensitive adhesive primer, depending on the type of the pressure-sensitive adhesive as a material for forming the pressure-sensitive adhesive layer 12. When such a pressure-sensitive adhesive is used, therefore, a certain pressure-sensitive adhesive primer is preferably used. The pressure-sensitive adhesive primer is generally provided on the second transparent resin film 20 side.

The pressure-sensitive adhesive primer may be of any type as long as it can improve the anchoring force of the pressure-sensitive adhesive. Examples of the pressure-sensitive adhesive primer that may be used include so-called coupling agents such as a silane coupling agent having a reactive functional group such as an amino, vinyl, epoxy, mercapto, or chloro group and a hydrolyzable alkoxysilyl group in the same molecule, a titanate coupling agent having an organic functional group and a titanium-containing hydrolyzable hydrophilic group in the same molecule, and an aluminate coupling agent having an organic functional group and an aluminum-containing hydrolyzable hydrophilic group in the same molecule; and a resin having an organic reactive group, such as an epoxy resin, an isocyanate resin, a urethane resin, or an ester urethane resin. In particular, a silane coupling agent is preferred, because it is easy to handle industrially.

The second transparent resin film 20 may be of the same type as the first transparent resin film 10. The second transparent resin film 20 may be made of the same material as the first transparent resin film 10. The second transparent resin film generally has a thickness of 10 to 200 μm, preferably 20 to 100 μm.

A transparent conductive layer 22 may be provided directly on the other side of the second transparent resin film 20, where the pressure-sensitive adhesive layer 12 is not bonded, or provided on the other side of the second transparent resin film 20 with an undercoat layer interposed therebetween.

When the transparent conductive layer 22 is provided on the second transparent resin film 20 to form a transparent conductive film, the second transparent resin film 20 preferably has a thickness of 10 to 40 μm, more preferably 20 to 30 μm. If the thickness of the second transparent resin film 20 used to form a transparent conductive film is less than 10 μm, the mechanical strength of the second transparent resin film 20 may be insufficient, so that it may be difficult to perform the process of continuously forming the transparent conductive layer 22 on the second transparent resin film 20 being fed from a roll. If the thickness is more than 40 μm, the amount of introduction of the second transparent resin film 20 may be reduced in the process of forming the transparent conductive layer 22, and the process of removing gas or moisture may be hindered, so that the productivity may be reduced. In this case, it may also be difficult to reduce the thickness of the transparent conductive laminated film.

The surface of the second transparent resin film 20 may be previously subjected to sputtering, corona discharge treatment, flame treatment, ultraviolet irradiation, electron beam irradiation, chemical treatment, etching treatment such as oxidation, or undercoating treatment so that the second transparent resin film 20 can have improved adhesion to the transparent conductive layer 22 or the undercoat layer 21 to be provided thereon. If necessary, it may also be subjected to dust removing or cleaning by solvent cleaning, ultrasonic cleaning, or the like, before the transparent conductive layer 22 or the undercoat layer 21 is formed.

For example, materials that are preferably used to form the transparent conductive layer 22 include, but are not limited to, tin oxide-doped indium oxide, antimony-doped tin oxide, and others. When any of the above materials are used to form the transparent conductive layer 22, the transparent conductive layer 22 can be made amorphous by controlling the content of tin oxide in the material (by adding tin oxide in a predetermined amount). When an amorphous transparent conductive layer is formed, the metal oxide preferably contains 90 to 99% by weight of indium oxide and 1 to 10% by weight of tin oxide, more preferably 95 to 98% by weight of indium oxide and 2 to 5% by weight of tin oxide. After the transparent conductive layer 22 is formed, if necessary, annealing may be performed in the range of 100 to 150° C. for crystallization. Alternatively, the amorphous transparent conductive thin layer may be crystallized by a heat treatment after the laminated film of the invention is formed. The crystallization may be performed using the same heating temperature (100 to 150° C.) as the annealing.

As used therein, the term “amorphous” means that when the surface of the transparent conductive thin layer is observed using a field emission transmission electron microscope (FE-TEM), the ratio of the area occupied by polygonal or elliptical crystals to the whole surface area of the transparent conductive thin layer is 50% or less (preferably 0 to 30%).

The thickness of the transparent conductive layer 22 is preferably, but not limited to, 10 nm or more, in order that it may form a highly-conductive continuous layer with a surface resistance of 1×10³ Ω/square or less. If the thickness is too large, a problem such as a reduction in transparency may occur. Therefore, the thickness is preferably from 15 to 35 nm, more preferably from 20 to 30 nm. If the thickness is less than 15 nm, the surface electric resistance may be too high, and it may be difficult to form a continuous layer. If the thickness is more than 35 nm, a problem such as a reduction in transparency may occur.

The method of forming the transparent conductive layer 22 is not restricted, and it may be formed using conventionally known methods. Examples of such methods include vacuum deposition, sputtering, and ion plating. Any appropriate method may also be used depending on the required film thickness.

The undercoat layer 21 may be made of an inorganic material, an organic material, or a mixture of inorganic and organic materials. The undercoat layer 21 may be formed of a single layer or two or more layers. When two or more layers are formed, any combination may be used.

Examples of the inorganic material include NaF (1.3), Na₃AlF₆ (1.35), LiF (1.36), MgF₂ (1.38), CaF₂ (1.4), BaF₂ (1.3), SiO₂ (1.46), LaF₃ (1.55), CeF₃ (1.63), Al₂O₃ (1.63), and other inorganic materials, wherein the value in each pair of parentheses is the light refractive index of each material. Among them, SiO₂, MgF₂, and Al₂O₃ are preferably used, and SiO₂ is particularly preferred. Besides the above, a complex oxide containing 100 parts by weight of indium oxide, about 10 to about 40 parts by weight of cerium oxide, and 0 to about 20 parts by weight of tin oxide may also be used.

Using the inorganic material, the undercoat layer can be formed by a dry process such as vacuum deposition, sputtering, or ion plating, or a wet process (a coating method). As described above, SiO₂ is preferably used as an inorganic material to form the undercoat layer. In a wet process, a silica sol or the like may be applied so that a SiO₂ layer can be formed.

Examples of the organic material include acrylic resin, urethane resin, melamine resin, alkyd resin, siloxane-based polymers, and organosilane condensates. At least one of these organic materials may be used. In particular, a thermosetting resin including a mixture of a melamine resin, an alkyd resin, and an organosilane condensate is preferably used.

The thickness of the undercoat layer is generally, but not limited to, about 1 to about 300 nm, preferably 5 to 300 nm, in view of optical design and the effect of preventing the occurrence of oligomers from the second transparent resin film 20. When two or more undercoat layers 21 are provided, each layer may have a thickness of about 5 to about 250 nm, preferably 10 to 250 nm.

In the process of producing the laminated film 2(B) shown in FIG. 2B, the transparent conductive layer 22 of the laminated film 2(B) may be an amorphous transparent conductive thin layer made of a metal oxide, and in this case, the amorphous transparent conductive thin layer may be crystallized by heating.

### EXAMPLES

Hereinafter, the invention is described in more detail with reference to the examples, which however are not intended to limit the gist of the invention.

### <Measurement of Thickness of Oligomer Blocking Layer>

Si intensity ratios were determined using a fluorescent X-ray analyzer manufactured by RIGAKU CORPORATION, and the thickness was calculated from a calibration curve prepared from the Si intensity ratios.

### Example 1

### Preparation of Oligomer Blocking Layer-Forming Material

A silica sol (COLCOAT P manufactured by COLCOAT CO., Ltd.) was diluted with ethanol to a solid concentration of 2%, and the resulting solution was used.

### (Formation of Oligomer Blocking Layer)

The oligomer blocking layer-forming material was applied to one surface of a 125 μm thick polyethylene terephthalate film (hereinafter referred to as “PET film 1”) as a first transparent resin film by a silica coating method. Subsequently, the coating was heated at 150° C. for 2 minutes so that it was dried and cured to form a 20 nm thick oligomer blocking layer. As a result, an oligomer blocking layer-attached PET film 1 was obtained.

### (Preparation of Pressure-Sensitive Adhesive Layer-Attached PET Film 1)

A pressure-sensitive adhesive layer was formed on the oligomer blocking layer of the oligomer blocking layer-attached PET film 1, so that a pressure-sensitive adhesive layer-attached hard-coat film was obtained. The pressure-sensitive adhesive layer was a transparent acrylic pressure-sensitive adhesive layer (1.47 in refractive index) with a thickness of 20 μm and an elastic modulus of 10 N/cm². The pressure-sensitive adhesive layer was produced using a composition containing 100 parts by weight of an acryl-based copolymer of butyl acrylate, acrylic acid, and vinyl acetate (100:2:5 in weight ratio) and 1 part by weight of an isocyanate crosslinking agent.

### (Preparation of Transparent Conductive Film)

In a 0.4 Pa atmosphere composed of 80% argon gas and 20% oxygen gas, a 25 nm thick ITO layer was formed on one surface of a 25 μm thick polyethylene terephthalate film (hereinafter referred to as PET film 2) as a second transparent resin film by a reactive sputtering method using a sintered material of 90% by weight of indium oxide and 10% by weight of tin oxide under the conditions of a PET film 2 temperature of 100° C. and a discharge power of 6.35 W/cm², so that a transparent conductive film was obtained. The ITO layer was amorphous.

### (Preparation of Transparent Conductive Laminated Film)

The pressure-sensitive adhesive layer of the pressure-sensitive adhesive layer-attached PET film 1 was bonded to the surface of the PET film 2 of the transparent conductive film, on the side where the transparent conductive layer was not provided, so that a transparent conductive laminated film was obtained. The resulting transparent conductive laminated film was heat-treated at 140° C. for 90 minutes so that the amorphous ITO layer was crystallized.

### Examples 2 and 3 and Comparative Examples 1 and 2

Each oligomer blocking layer-attached PET film 1 was obtained as in Example 1, except that the thickness of the oligomer blocking layer was changed as shown in Table 1 in the process of forming the oligomer blocking layer.

And each pressure-sensitive adhesive layer-attached PET Film 1 was obtained, as in Example 1, further each transparent conductive laminated film was also obtained, as in Example 1, except the resulting oligomer blocking layer-attached PET film 1 was used.

The oligomer blocking layer-attached PET film 1 and the transparent conductive laminated film obtained in each of the examples and the comparative examples were evaluated as described below. The results are shown in Table 1.

### <Adhesion Between Oligomer Blocking Layer and Pressure-Sensitive Adhesive Layer>

Each oligomer blocking layer-attached PET film 1 was cut into a 50 mm×50 mm sample. The PET film 1 side of the sample was bonded to a 5 mm thick glass plate with a 5 μm thick pressure-sensitive adhesive layer formed using the pressure-sensitive adhesive of Example 1, in such a manner that the oligomer blocking layer side was located on the front side. Subsequently, 11 cut lines were formed on the oligomer blocking layer in every direction at intervals of 1 to 2 mm with a cutter knife so that 100 cross-cuts were formed in total. A cellophane tape manufactured by NICHIBAN CO., LTD. (Product No. 405, 20 mm or more in length) was applied onto the cross-cuts and then completely bonded to the oligomer blocking layer by rubbing the tape with a paddle. Subsequently, the tape was grasped at the end and pulled out quickly at an angle of near 90°. Whether and how the oligomer blocking layer at the cross-cuts peeled off was checked visually, and the peeling state was evaluated according to the criteria below.

◯: No peeling was observed.
Δ: Peeling was observed at less than ¼ part of the cross-cuts.
x: Peeling was observed at ¼ or more part of the cross-cuts.

### <Oligomer Blocking Capability>

The transparent conductive laminated film was cut into a 50 mm×50 mm sample. The sample was stored in heating environments at 140° C. and 150° C., respectively, for 2 hours. The storage in the environment at 150° C. for 2 hours corresponds to a severe test. The heat-treated sample was further placed in an heating environment at 80° C. and a humidifying environment at 60° C. and 95% RH, respectively, for 240 hours, and then observed visually (using CCD microscope) for the presence of oligomer crystals (10 μm or more in size) and evaluated according to the criteria below.

◯: No oligomer crystal was observed.
Δ: Oligomer crystals were slightly observed.
x: A large number of oligomer crystals were observed.

### <Interlayer Adhesion>

The transparent conductive laminated film was cut into a 100 mm×100 mm sample. The sample was heated at 150° C. for 1 hour and then placed in a humidifying environment at 60° C. and 95% RH for 500 hours. Subsequently, an end part of the treated sample was peeled off by hand, and the PET film 1 side was fixed onto a tension tester manufactured by Shimadzu Corporation (product name: Tensilon). The interlayer adhesive strength (N/10 mm) required when the PET film 2 side (transparent conductive film) was peeled off in a 180° direction at a rate of 10 m/min was measured and evaluated according to the criteria below.

⊙: The adhesive strength was 2.5 N/10 mm or more.
◯: The adhesive strength was from 1.5 to less than 2.5 N/10 mm.
x: The adhesive strength was less than 1.5 N/10 mm.

TABLE 1

| | | | Evaluation | | | | |
|---|---|---|---|---|---|---|---|
| | | | Adhesion | | | | |
| | | | between | | | | |
| | | | oligomer | | | | |
| | | | blocking | | | | |
| | Oligomer | | layer and | | | Interlayer | |
| | blocking | | pressure- | Oligomer precipitation | | adhesion | |
| | layer | | sensitive | Preliminary | Preliminary | | Adhesive |
| | | Thickness | adhesive | heating | heating | | strength |
| | Material | (nm) | layer | 140° C. | 150° C. | Judgment | (N/10 mm) |
| Example 1 | Silica | 20 | ◯ | ◯ | ◯ | ⊙ | 3.0 |
| | sol | | | | | | |
| Example 2 | Silica | 35 | ◯ | ◯ | ◯ | ◯ | 2.2 |
| | sol | | | | | | |
| Example 3 | Silica | 10 | ◯ | ◯ | Δ | ⊙ | 4.8 |
| | sol | | | | | | |
| Comparative | Silica | 50 | X | ◯ | ◯ | X | 1.1 |
| Example 1 | sol | | | | | | |
| Comparative | Silica | 75 | X | ◯ | ◯ | X | 0.7 |
| Example 2 | sol | | | | | | |

What is claimed is:

1. A pressure-sensitive adhesive layer-attached transparent resin film, comprising a first transparent resin film, an oligomer blocking layer, and a pressure-sensitive adhesive layer, which are laminated in this order,
wherein the oligomer blocking layer is made of a curing product of alkoxysilane and/or a partial condensate thereof, and
the oligomer blocking layer has a thickness of 5 nm to 35 nm.

2. The pressure-sensitive adhesive layer-attached transparent resin film according to claim 1, wherein the first transparent resin film is a polyester resin film.

3. The pressure-sensitive adhesive layer-attached transparent resin film according to claim 1, wherein the pressure-sensitive adhesive layer is an acrylic pressure-sensitive adhesive layer.

4. A laminated film, comprising the pressure-sensitive adhesive layer-attached transparent resin film according to claim 1 and a second transparent resin film bonded thereto with the pressure-sensitive adhesive layer of the pressure-sensitive adhesive layer-attached transparent resin film interposed therebetween.

5. The laminated film according to claim 4, wherein the second transparent resin film is a transparent conductive film having a transparent conductive layer placed directly on one side where the pressure-sensitive adhesive layer is not bonded, or placed on the one side with an undercoat layer interposed therebetween.

6. A touch panel comprising the laminated film according to claim 5 having the transparent conductive film.
